(19) United States
(12) Patent Application Publication
(10) Pub. No.: US 2015/0323088 A1
(43) Pub. Date: Nov. 12, 2015

(54) Magnetic Breather Valve

(71) Applicant: AGM Container Controls, Inc., Tucson, AZ (US)

(72) Inventor: Eric J. Zuercher, Tucson, AZ (US)

(73) Assignee: AGM Container Controls, Inc., Tucson, AZ (US)

(21) Appl. No.: 14/272,849

(22) Filed: May 8, 2014

(51) Int. Cl. F16K 17/164; F16K 31/00

(52) U.S. Cl. CPC F16K 17/164; F16K 31/003

(57) ABSTRACT

Breather valves featuring magnets that allow very rapid flow. Such flow is accomplished by a valve housing enclosing a hollow interior portion containing a stationary member including a magnet and a pressure-movable poppet disposed in sealing arrangement with the housing and including a magnet. Additionally, and a return force member, such as a magnet or spring, between and coupled to the cover of the housing and the pressure movable poppet may be incorporated into the breather valve. The magnets are substantially centrally disposed in relation to the stationary member and pressure-moveable poppet and are configured such that the breather valve stays closed until an air pressure overcomes an attraction force between the magnets, thereby opening the valve.

### BACKGROUND OF THE INVENTION

1. Field of the Invention

The embodiments described herein relate to improved breather valve assemblies especially useful in venting containers and the like.

2. Description of the Related Art

Breather valves, also known as pressure relief valves, prevent excessive pressure or vacuum buildup in sealed containers, which reduces container weight, cube, and cost. A variety of breather valves have been developed over the years, including valves that keep dust, water, and blowing sand from entering containers.

In some applications, the pressure or vacuum differential versus flow rate profile of a breather valve can be a critical factor in whether a sealed container will deform (or even explode). In other words, if a breather valve cannot expel or intake air fast enough, damage to the container and contents can result.

One specific container pressure-buildup situation that occurs during air transport is the rapid decompression event, when the air pressure outside the container drops precipitously. This can occur when an aircraft hold suddenly loses pressure while the aircraft is at high altitude, and the containers in the hold need to be depressurized very quickly. A container that cannot equalize pressure quickly might explode, thereby putting the aircraft and persons at risk.

While traditional two-way breather valves can effectively defuse rapid decompression events for small containers, they usually have insufficient flow capacity for containers with volumes larger than several cubic feet. The reason for this is that a traditional valve depends upon a compression spring to keep its poppet closed, and, although the poppet needs to open as far as possible to maximize the valve's air flow, the poppet meets with increasing opening resistance from the compression spring the farther it opens. This behavior of the compression spring limits the maximum flow rate of the valve.

### SUMMARY OF THE INVENTION

In one aspect, breather valves featuring magnets that allow very rapid gas or air flow are disclosed. This flow is accomplished by a valve housing enclosing a hollow interior portion containing a stationary member including a magnet and a pressure-movable poppet disposed in sealing arrangement with the housing and including a magnet. A return force member, such as a spring or magnet, may be added to close the movable poppet. The magnets are substantially centrally disposed in relation to the stationary member and pressure-moveable poppet and are configured such that the breather valve stays closed until an air pressure overcomes an attraction force between the magnets, thereby opening the valve.

Thus, this disclosure generally relates to an improved breather valve that utilizes a pair of magnets rather than a compression spring to hold its poppet closed. This design yields a higher flow rate than a spring-actuated valve because the attraction between two magnets decreases with the square of the distance between them. This means that once the poppet overcomes the threshold pressure and the valve opens, the force holding the poppet closed actually decreases rather than increases. The only force acting on the poppet to close it again is either the attraction of the pair of magnets or a return force member. For example, a third magnet or weak compression spring that is just strong enough to push the poppet closed against a zero pressure differential may be utilized.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 depicts a perspective view of a magnetic breather valve embodiment.

FIG. 2 depicts a perspective, cut-away view of the breather valve embodiment of FIG. 1.

FIG. 3 illustrates the valve of FIG. 1 in a closed position.

FIG. 4 illustrates the valve of FIG. 1 in an open position.

FIG. 5 is a chart that shows the flow characteristics of both a magnetically-actuated valve and a traditional spring-actuated valve (both valves have a two-inch diameter).

### DETAILED DESCRIPTION OF THE PREFERRED EMBODIMENTS

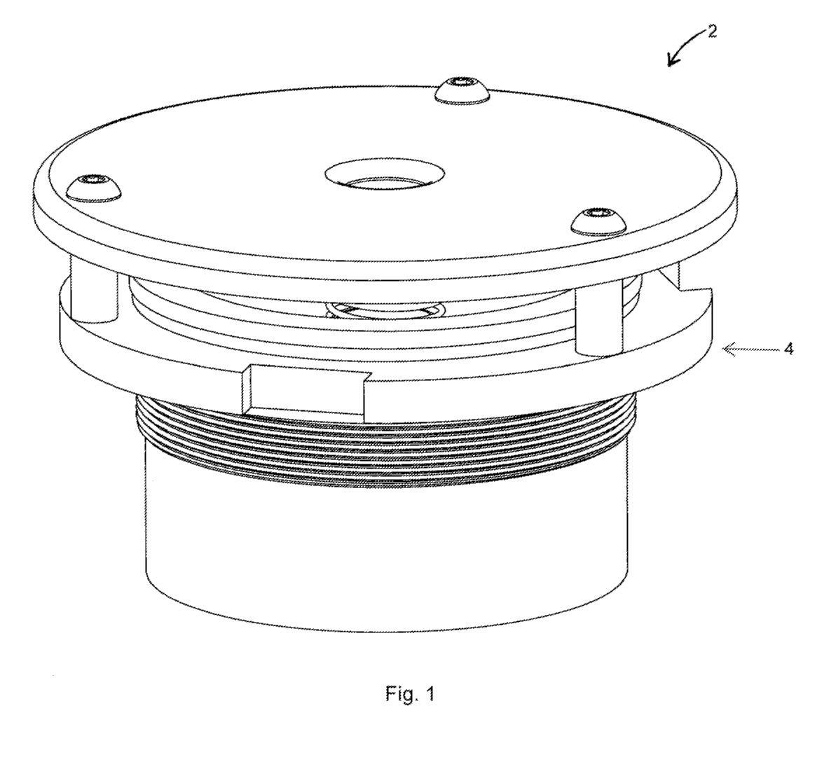

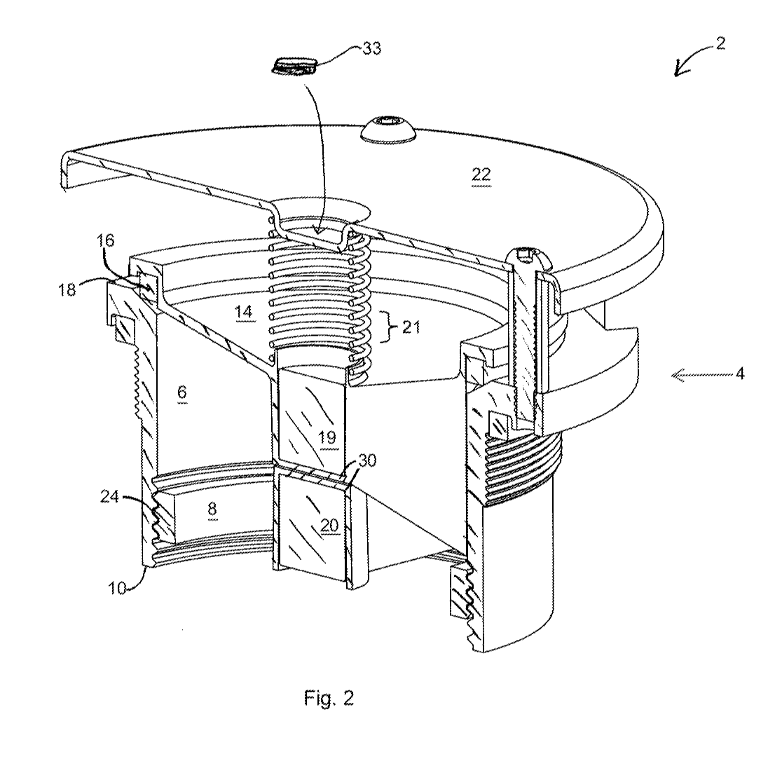

As shown in perspective view in FIG. 1, a breather valve 2 is generally depicted that includes a valve housing 4. Turning to the cut-away view of FIG. 2, the valve housing 4 encloses a hollow interior portion 6 that contains a stationary member 8 coupled with and disposed proximally to a bottom end 10 of the housing. A pressure-movable poppet 14 is disposed in sealing arrangement (for example, by virtue of having sealing ring 16) proximally to a top end 18 of the housing 4. The stationary member 8 and the pressure-moveable poppet 14 each include a magnet, i.e., magnets 19 and 20.

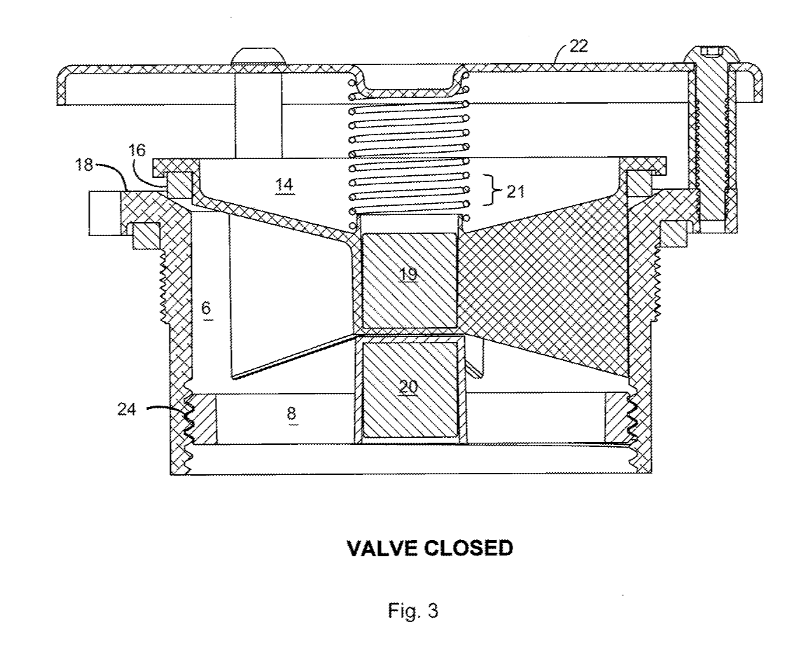

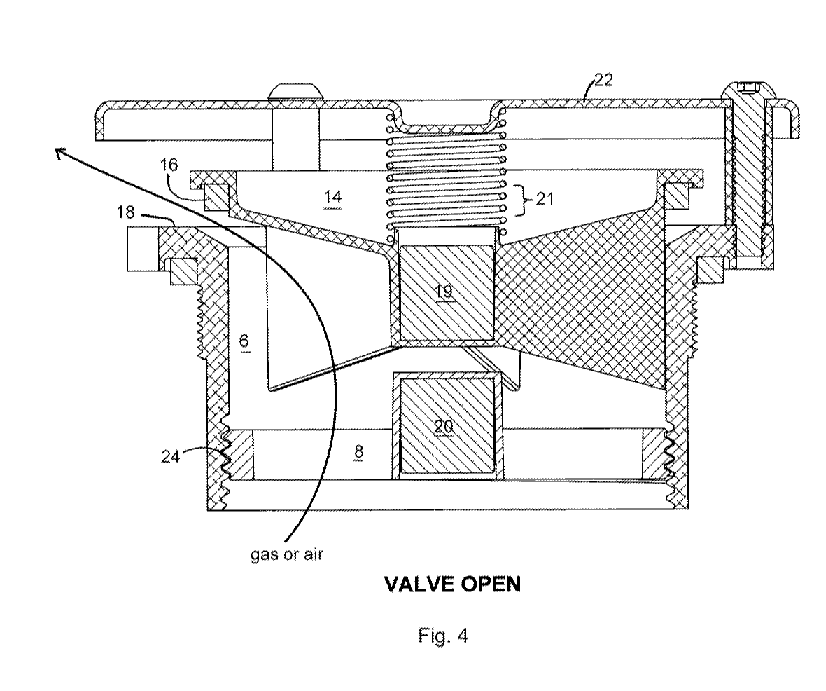

Preferably, magnets 19 and 20 are substantially centrally disposed in relation to the stationary member 8 and pressure-moveable poppet 14 and are configured such that the breather valve 2 stays closed until a gas or air pressure overcomes an attraction force between the magnets, thereby opening valve by “lifting” poppet 14 such that sealing ring 16 is raised (see FIG. 3 versus FIG. 4) and gas or air flows out of the breather valve. Once the pressure differential acting on valve 2 is approximately zero, the attraction of magnets 19 and 20 can induce the poppet to close. By adjusting the separation distance of the magnets so that there is always enough attractive force to return the poppet to the closed position, one may also have the poppet close at pressure differentials other than zero.

Nonetheless, it has been found that the attraction of magnets 19 and 20 alone may not be sufficient to close the poppet consistently in all orientations. For example, when the valve is oriented so that gravity is pulling the poppet open, the magnets coupled with the poppet and stationary member may not be strong enough to pull the poppet closed again. Thus, a return force member may be added. The return force member may be, for example a spring 21 or a third magnet 33 disposed at the top 22 or under the top. The spring or magnet is not strong enough to impede the flow significantly, just strong enough to close the poppet under about zero pressure differential.

In some applications, it was found that even a stainless steel spring is magnetic enough to get pulled to its solid height by the large, powerful magnets in the 4″-diameter valve. Accordingly, a non-magnetic (e.g., phosphor bronze spring) is preferred in such applications. In the depicted embodiment, a phosphor bronze return spring 21 is present between and coupled to a cover 22 of the housing and the pressure movable poppet.

As shown in this one preferred embodiment, the valve housing 4 is cylindrical and contains a threaded portion 24 along the hollow interior portion 6. Thus, the stationary member 8 can threadedly engage the threaded portion 24, thereby making stationary member adjustable such that the distance (and thus attraction force) between magnets 19 and 20 is adjustable.

Preferably, the valve is made from aluminum with a polycarbonate poppet and silicone seals. However, any suitably rigid plastic or other material may be used. Also preferably, the magnets are nickel-plated neodymium.

Conceiving of the improved breather valve was not straight forward. On the one hand, the pair of magnets had to be capable of keeping their properties over a wide range of temperatures and of providing a large amount of force (in keeping the poppet closed) in a fairly compact volume. On the other hand, the magnets could not be so powerful as to interfere with electronic equipment (such as aircraft avionics) and had to be prevented from striking each other upon closing, which could lead to damage. Thus, the magnets preferably are covered in plastic 30.

The magnet valve is a design that improves upon “traditional” valve designs in that it yields much higher air flow. Traditional valves utilize compression springs for sealing, which means that the spring force on the valve's poppet increases linearly as the valve opens. However, the magnet design replaces the compression spring with a pair of magnets, whose attraction forces for each other decrease with the square of the distance of separation. This allows far more air to pass through the valve at a given pressure differential. In fact, the pressure differential between the inside and outside of a container can be almost completely eliminated, which is nearly impossible for a “traditional” breather valve.

This inventive valve will be useful for many applications that require a maximum amount of air flow in the smallest possible valve. Its most apparent application is for rapid decompression events, during which an aircraft hold suddenly loses pressure, and containers in the hold need to be depressurized very quickly to avoid catastrophic damage.

It was found that the flow performance of the valves is mostly independent of the cracking point. As soon as the poppet opens, it “flies” all of the way open and stays open so long as a pressure differential and flow are maintained. So, a valve that opens at ½ psi flows the same amount of air as a valve that opens at 2 psi, in the pressure region where both valves are open. This is drastically different from a traditional valve with a compression spring, where a valve with a higher cracking point will flow less air than a valve with a lower cracking point, at all pressure points. For a traditional valve, not only is the pressure versus flow curve for higher cracking valves translated to the right, but the curve is flattened.

One unexpected consequence of the magnet valve's flow characteristics is that it allows more air entry into storage containers and therefore more moisture ingress. One of the primary sources of pressure differentials in containers that breather valves are used to relieve is diurnal temperature variations during container storage. A breather valve will prevent the container from exploding or imploding due to pressure or vacuum buildups. Therefore, it is expected that the primary market for this valve is for rapid decompression requirements, where a valve needs to exhaust a large amount of air in a short period of time. This occurs during air flight rather than during long term storage, so air and moisture ingress is not a concern (additionally, the air flow during rapid decompression is always outward). This means that the magnet valve as a one-way pressure relief valve rather than as a 2-way valve.

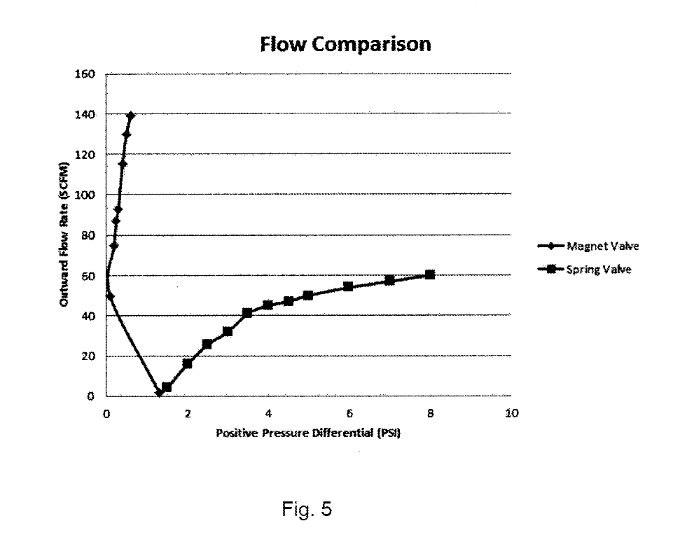

FIG. 5 is a chart that shows the flow characteristics of both a magnetically-actuated valve and a traditional spring-actuated valve (both have a two-inch diameter). While both valves open between 1.0 and 1.5 psi differential, the pressure behind the magnet valve falls immediately after the valve opens and barely climbs back to 0.6 psi before the capacity of the flow measurement is reached (140 Standard Cubic Feet per Minute, or SCFM). The spring valve, by comparison, only reaches 60 SCFM at a very high (for a container) pressure differential of 8 psi. Accordingly, the magnet valve yields far more flow than the spring valve, even though the opening pressure of both valves in nearly identical, and both valves fit into a 2-inch diameter mounting hole.

Another unique feature of the flow through the magnet valve is that the pressure drop across the valve actually falls with increasing flow, at least until the poppet is fully open. This behavior is also far different from the behavior of a traditional breather valve, where an increase in flow is always accompanied by a rise in pressure differential.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made there from within the scope of the invention, which is not to be limited to the details disclosed herein but is to be accorded the full scope of the claims so as to embrace any and all equivalent processes and products. All references cited in this application are hereby incorporated by reference herein.

What is claimed is:

1. A breather valve, comprising:
a valve housing enclosing a hollow interior portion containing a stationary member coupled proximally to a bottom end of said housing, said stationary member including a magnet; and
a pressure-movable poppet disposed in sealing arrangement proximally to a top of said housing and including a magnet, wherein
said magnets are substantially centrally disposed in relation to said stationary member and pressure-moveable poppet and are configured such that said breather valve stays closed until an air pressure overcomes an attraction force between said magnets, thereby opening said valve.

2. The valve of claim 1, wherein said valve housing is cylindrical and contains a threaded portion along said hollow interior portion.

3. The valve of claim 2, where said stationary member threadedly engages said threaded portion.

4. The valve of claim 3, wherein said stationary member is adjustable within said threaded portion such that said attraction force between said magnets is adjustable.

5. The valve of claim 1, further comprising a return force member between and coupled to a cover of the housing and said pressure movable poppet.

6. The valve of claim 5, wherein said return force member is a magnet disposed such that it repulses said pressure movable poppet magnet.

7. The valve of claim 5, wherein said return force member is a spring.

8. The valve of claim 7, wherein said return spring comprises a non-magnetic material.

9. The valve of claim 8, wherein said return spring comprises phosphor-bronze.

10. The valve of claim 5, wherein said return force member actuates the poppet to a closed position when a pressure differential reaches approximately zero.

11. A breather valve, comprising:
a valve housing enclosing a hollow interior portion containing a stationary member coupled proximally to a bottom end of said housing, said stationary member including a magnet; and
a pressure-movable poppet disposed in sealing arrangement proximally to a top outer circumference of said housing and including a magnet; wherein
said magnets are covered such that no direct contact is made between magnets when the valve is no the closed position, said magnets are substantially centrally disposed in relation to said stationary member and pressure-moveable poppet, and said magnets are configured such that said breather valve stays closed until an air pressure overcomes an attraction force between said magnets, thereby opening said valve.

12. The valve of claim 11, wherein said valve housing is cylindrical and contains a threaded portion along said hollow interior portion.

13. The valve of claim 12, where said stationary member threadedly engages said threaded portion.

14. The valve of claim 13, wherein said stationary member is adjustable within said threaded portion such that said attraction force between said magnets is adjustable.

15. The valve of claim 11, further comprising a return force member between and coupled to a cover of the housing and said pressure movable poppet.

16. The valve of claim 15, wherein said return force member is a magnet disposed such that it repulses said pressure movable poppet magnet.

17. The valve of claim 15, wherein said return force member is a spring.

18. The valve of claim 17, wherein said return spring comprises a non-magnetic material.

19. The valve of claim 18, wherein said return spring comprises phosphor-bronze.

20. The valve of claim 15, wherein said return force member actuates the poppet to a closed position when a pressure differential reaches approximately zero.
